(19) United States
(12) Patent Application Publication
(10) Pub. No.: US 2006/0167832 A1
(43) Pub. Date: Jul. 27, 2006

(54) System management technique to surface the most critical problems first

(76) Inventors: Joshua Shane Allen, Durham, NC (US); Richard Walton Ragan JR., Round Rock, TX (US); Wayne B. Riley, Cary, NC (US)

Correspondence Address: IBM CORP (YA);C/O YEE & ASSOCIATES PC, P.O. BOX 802333, DALLAS, TX, 75380, US

(21) Appl. No.: 11/044,368

(22) Filed: Jan. 27, 2005

(51) Int. Cl. G06F 17/30

(52) U.S. Cl. 707/1

(57) ABSTRACT

A method, apparatus and computer instructions are provided to identify problems that are most critical to the revenue of a business. Configuration of business management software is facilitated in a way to ensure that the most severe revenue impacts are addressed first. An administrator is interrogated for those systems, resources and customers whom the business feels are most important to the business' bottom line. Through a rule-based set of GUI constructs, the administrator configures the software system to ensure the most severe problems are addressed first.

### BACKGROUND OF THE INVENTION

1. Technical Field

The present invention relates to data processing. More particularly, the present invention relates to system management software that identifies problems that are most critical to the revenue of the business.

2. Description of Related Art

A business system manager is a tool that provides control of a set of the functions of a business, real time cost analysis of problems within the business, and evaluation and reporting of problems that occur within the operations of the business. One example of a business system manager is the IBM Tivoli® Business Systems Manager. The Tivoli® Business Systems Manager (TBSM) collects information of resources' status from various parts of the business enterprise. TBSM gets feeds from the mainframe environment, job scheduling subsystem, Tivoli® Framework, network management software, or other third party applications. TBSM processes all events from those feeds and shows an integrated view of an enterprise.

Related to IBM Tivoli® Monitoring for Databases, TBSM can show the status of DB2®, Oracle®, and Informix® resources as they relate to a business function. IBM Tivoli® Monitoring for Databases generates events through the resource models. Resource models define monitoring criteria and monitoring conditions. For example, a monitor can be configured via its resource model to fire an event when disk space falls below 50 MB. These events go through the Tivoli® Enterprise Console (TEC), and specialized TEC rules are employed to forward these events to TBSM. TBSM then processes these events as they show the database resources' status.

TBSM is a business systems management tool that enables operational personnel to graphically monitor and control interconnected business components and operating system resources. A business component and its resources are referred to as a Line of Business (LOB). The Tivoli® Business Systems Manager product consists of a Tivoli® Business Systems Manager management server, a Tivoli® Business Systems Manager console, and a Tivoli® Business Systems Manager Event Enablement component.

The Tivoli® Business Systems Manager management server processes all the availability data that is collected from various sources. Availability data is inserted in the Tivoli® Business Systems Manager database, where intelligent agents provide alerts on monitored objects and then broadcast those alerts to Tivoli® Business Systems Manager workstations. The management server processes all user requests that originate from the workstations and includes a database server that is built around a Microsoft® SQL Server database.

The Tivoli® Business Systems Manager console displays objects in customized views, called Line of Business Views. Objects are presented in a hierarchical Tree View so that users may see the relationships between objects. Alerts are overlaid on the objects when the availability of the object reports a change in status.

The Tivoli® Business Systems Manager Event Enablement component is installed on the Tivoli® Enterprise Console event server and enables the event server to forward events to Tivoli® Business Systems Manager. Tivoli® Event Enablement defines event classes and rules for handling events related to the Tivoli Business Systems Manager.

The Tivoli® Business Systems Manager gives operations personnel and business executives a graphical interface to quickly see and understand the health of the IT infrastructure they are using or managing. The Tivoli® Business Systems Manager shows business executives which business functions are impacted. The Tivoli® Business Systems Manager also shows operations personnel what business functions are affected by problems with a single component. In Tivoli® Business Systems Manager, the business function is represented by a Line of Business.

Some existing businesses use complex software and personnel to recognize which problems are most severe, so that those problems are recognized, prioritized and addressed before the less severe problems. Working less severe problems prior to the most severe problems may cause the most severe problems to produce more damage and higher cost to the company while the less severe problems are being addressed. In most scenarios, addressing the most severe problems prior to addressing the less severe problems may, in actuality, resolve some of the less severe problems.

Currently, determining which problems are most severe and which are less severe is loosely based upon the impact that the business will experience. That impact is based largely upon the knowledge of the operator addressing the problems and the operator's opinion of which resources and systems are most important to the business. With this type of determination, operators may, due to imperfect knowledge of the company's network, or more often, its business operations, be working on problems which do not address the issues which are most important to the actual business needs. IT-centric points of view focus upon fixing problems with IT resources and connectivity. On the other hand, business-impact points of view focus on keeping the business processes and business revenue working. By allowing the operators to see what business functions are impacted and the relative value to the business of the impacts, they are able to work the problems that have the highest impact to the business revenue stream.

### SUMMARY OF THE INVENTION

The present invention provides a method, apparatus and computer instructions to identify problems that are most critical to a business. The exemplary aspects of the present invention facilitate a way to configure business system management software to ensure the surfacing of the problems that have the greatest impact on the revenue stream first, from a business centric point of view. The exemplary aspects of the present invention interrogate a system administrator for those systems, resources and lines of business that the business feels are most important to the business' bottom line. In the present invention the system administrator may label the business services, resources, and revenue impacts directly with input from the business groups, or the system administrator may create a form that enables the business personnel to label their own business services directly into the software. All of the various groups within the business (e.g. IT, Finance, Order processing, Sales) may provide their input as to which systems, resources and lines of business are most important to the revenue of the company.

Through a dynamic rule-based set of GUI constructs, the administrator, with input from the business groups, configures the software system to ensure the most critical revenue-related problems are addressed first. The interactions between business services can be inputted to yield a higher order view of how the failures in business services affect the overall revenue to the company. Other sources include out-of-box type rules for assessing impact to the business, such as total number of businesses impacted, scope of the problem, etc. A final source could include processes and rules from the business side, as opposed to the IT side of the company.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system in which the present invention may be implemented;

FIG. 4 is a high-level flow diagram illustrating the process of addressing and assigning problems to operators in accordance with a preferred embodiment of the present invention;

FIG. 5 is a flow diagram illustrating the method of assigning a value to each queued problem in accordance with a preferred embodiment of the present invention;

FIG. 6 is a diagram depicting an exemplary equation used to calculate a criticality value in accordance with an exemplary embodiment of the present invention; and

FIG. 7 is an exemplary diagram depicting the contribution of each criticality contributor to the criticality value in accordance with an exemplary embodiment of the present invention.

### DETAILED DESCRIPTION OF THE PREFERRED EMBODIMENT

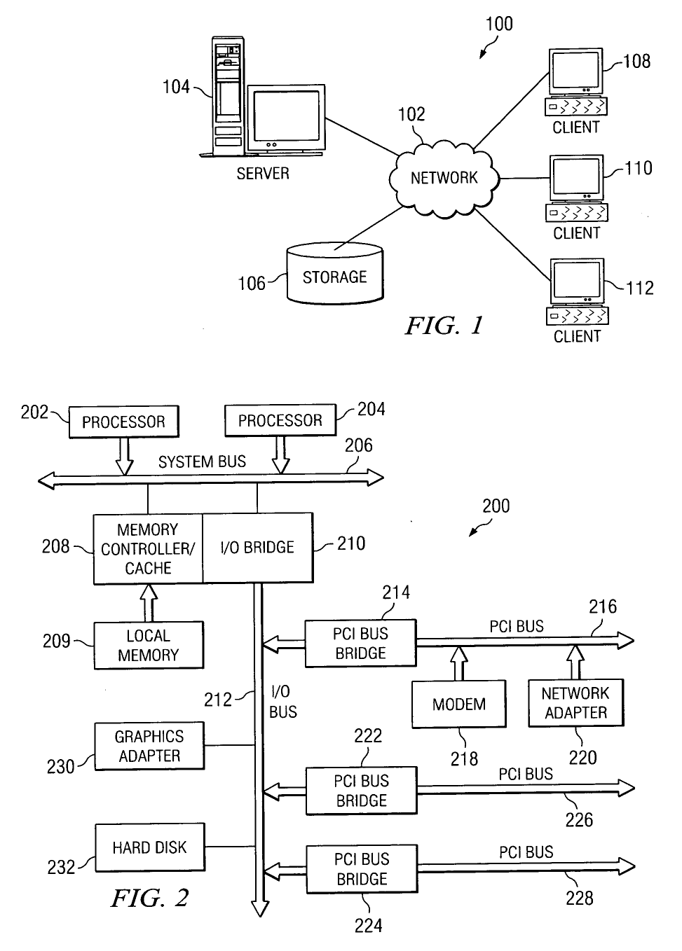

The present invention provides a method, apparatus and computer instructions to identify those problems which are most critical to a business. The data processing device may be a stand-alone computing device or may be a distributed data processing system in which multiple computing devices are utilized to perform various aspects of the present invention. Therefore, the following FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In accordance with a preferred embodiment of the present invention, server 104 provides application integration tools to application developers for applications that are used on clients 108, 110, 112. More particularly, server 104 may provide access to application integration tools that will allow two different front-end applications in two different formats to disseminate messages sent from each other.

In accordance with one preferred embodiment, a dynamic framework is provided for using a graphical user interface (GUI) for configuring business system management software. This framework involves the development of user interface (UI) components for business elements in the configuration of the business system management software, which may exist on storage 106. This framework may be provided through an editor mechanism on server 104 in the depicted example. The UI components and business elements may be accessed, for example, using a browser client application on one of clients 108, 110, 112.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX™) operating system or LINUX operating system.

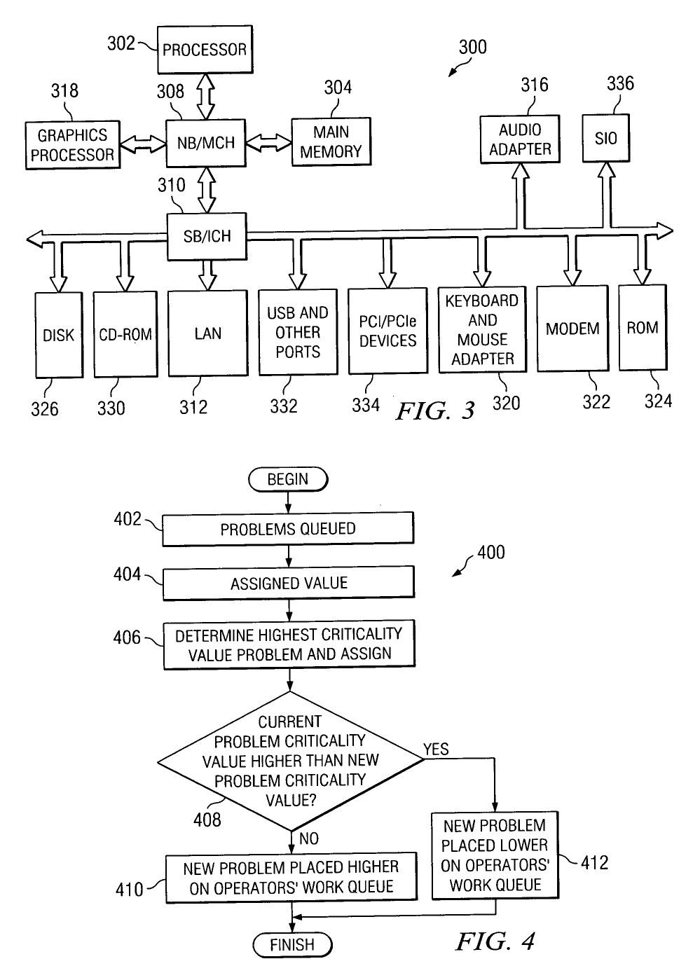

With reference now to FIG. 3, a block diagram of a data processing system is shown in which the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows XP™, which is available from Microsoft Corporation. An object oriented programming system, such as the Java™ programming system, may run in conjunction with the operating system and provides calls to the operating system from Java™ programs or applications executing on data processing system 300. “JAVA” is a trademark of Sun Microsystems, Inc.

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

Turning now to FIG. 4, a high-level flow diagram 400 illustrating the process of addressing and assigning problems to operators is depicted in accordance with a preferred embodiment of the present invention. Many businesses may use a Network Operations Center to address problems such as network errors, system errors or customer specific problems. A Network Operating Center (NOC) usually contains a group of operators that are trained in addressing the problems that occur within the business's provided services. Within the NOC, incoming problems that are identified in a network, a system or reported by a customer are queued so that the problems may be addressed (block 402). Traditionally, IT assigns a status to each event based on the type of event. For example, a “server down” event is considered fatal and a “disk approaching full” event is considered a warning. This type of status is based on a very static and uninformed environment. For example, just because a server goes down, the status may not be critical if that server is used for something non-critical to the business's revenue. It may be more important to increase the disk space on the warning event because the event occurred on a service providing major revenue to the business. Using these traditional static event labels, the operators typically sorts the IT event status for all of the problems, e.g., fatal status, critical status, warning status, etc., and work from the most severe problems down to the least severe problems. Using the traditional static event labels, the operator would only have an IT perspective on the problems. Each resource, i.e., server, router, application is evaluated within its isolated IT context. On the other hand, as depicted in accordance with a preferred embodiment of the present invention, a method is provided for understanding problems in terms of importance to business revenue and dynamic context within the overall company status. The criticality value and its accompanying business impact information give a complete picture as to the business impact of any problem, how that problem compares to other problems, and the context within the overall company's current status. The criticality value provides a numerical value representing the severity of the event in relation to how the event impacts the business's operation. The incorporated business impact information provides data as to how an event will impact the business's operation and, thus the business's customers. As the problems enter the queue, each problem is assessed and assigned a value that represents the criticality of the problem to the business (block 404).

A comparison of the criticality values and the accompanying business context assigned to the problems in the queue is then performed (block 406). The problem having the highest criticality value with the most severe business revenue impact in the work queue is typically moved to the top of the queue so that it will be addressed first. One exemplary criticality range is 0-100, where 0 is extremely low and 100 is extremely high.

If there is already a problem at the top of the queue, the system compares the criticality value of the assigned problems and decides which problem has a higher criticality value and business impact (block 408). If the existing problem has a lower criticality value and less business impact than the new problem in the work queue, then the new problem is placed higher in the work queue (block 410) with the process terminating thereafter. If the existing problem has a higher criticality value than the new problem in the work queue, then the new problem is placed lower in the work queue (block 412) with the process terminating thereafter. Thus, the process creates a prioritized list of problems as they enter the queue. This prioritized list ensures that the most critical problems will be addressed in the order that resolves the most critical and business impacting problems first. Another preferred embodiment may place the problems in the work queue in the order they are processed and not necessarily in order of priority of the criticality values. Thereby, the queue would indicate priority by the provided criticality value alone. An addition to these preferred embodiments would allow the assignment of a problem to an operator only after an operator finishes addressing any pre-assigned problems. This is addressed by using a threshold technique, which is adjustable by the use of a learning algorithm. The threshold technique is described with regard to FIG. 7.

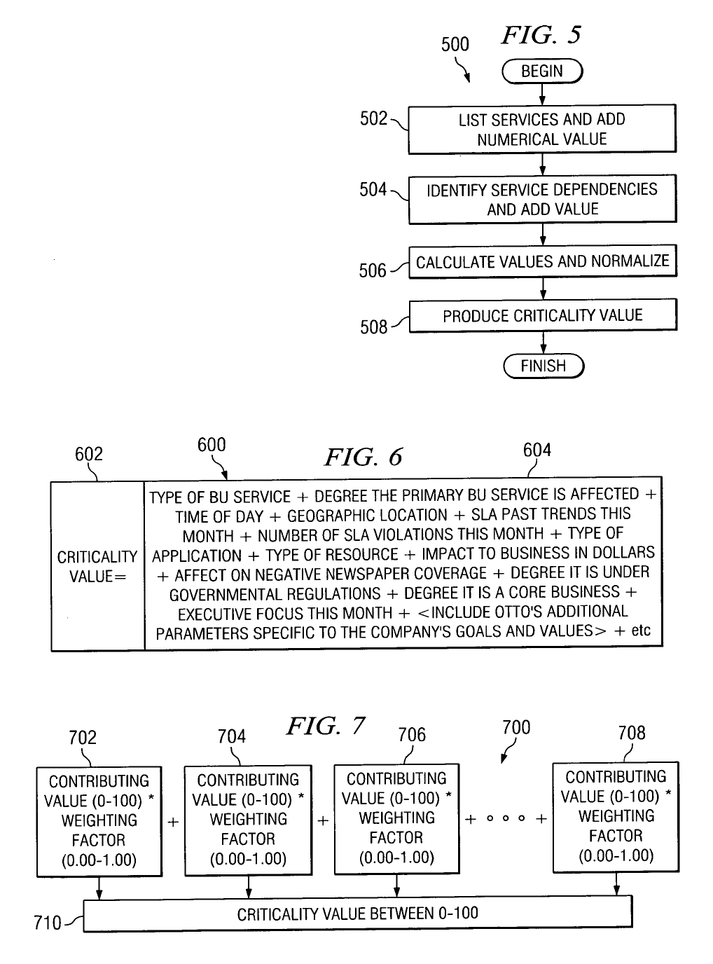

Turning now to FIG. 5, a flow diagram 500 illustrating the method of assigning a value to each queued problem of block 404 in FIG. 4 is depicted in accordance with a preferred embodiment of the present invention. In order to assign a value to the problems that arise within the operation of a business or within the services provided by the business, the business may be required to indicate all of the services that the business provides, the dependency of those services on business infrastructure, the revenue generated by the services, Service Level Agreements (SLAs) that govern the services provided, any degree of regulations that control the services provided, and other items that may directly affect the business providing a service to a customer. Problems that do not fall within the defined services are assigned a default value. When an assignment of a default value occurs, the administrator is alerted so that the problem may be given proper consideration by the business in the case that the problem occurs again. Thus, a business making use of the business system management software may list all of the services provided by the business and add a numeric value, or importance, on the services (block 502).

The numeric value added to the services is a dynamic value, which may change based on input gathered from the different entities within the business. An example of the numeric value would be: Numeric Value=(Incident Severity*Incident Weight)+(Business System Weight*[(Percentage of Daily Revenue*Revenue Weight)+(SLA Impact*SLA Weight)]). Using the following input examples of Incident Severity=75, Incident Weight=0.9 (90%), Business System Weight=0.65 (65%), Percentage of Daily Revenue=0.1 (10%), Revenue Weight=0.4 (40%), SLA Impact=20 and SLA Weight=0.5 (50%) would result in a Numeric Value=(75*0.9)+0.65*[(0.1*0.4)+(20* 0.5)]=74.03. The algorithm may be re-run on a given schedule or runs dynamically whenever a contributing value or weight changes. In addition, certain organizations may have a higher importance to the business and therefore can have greater weightings. An example being, some customers of the NOC may have “gold” status, while other customers may have “silver” status, while still others may have “bronze” status. Thus, importance is not a fixed variable. At any one time during the day, the importance of any one problem may change based on dynamic variables such as time of day, changes in marketing focus, changes in business processes, etc. These values may fluctuate based on time of day. For example, a business service such as retail operations has critical importance when the business is open between 10 am and 9 pm. When the store front is open, the customers purchase goods and revenue is collected. But retail operations are less important outside of those hours. The business may have purchase orders printed during the night, and therefore the computing resources supporting purchase order printing become more important during the night than the services of the retail operations, which is more important during the day. The business services change importance over the day as the support for the revenue changes.

Furthermore, the criticality value has business information including comparative values and business impact for each business system. The business groups (e.g., finance, order processing and sales) have previously provided input of their comparative values for each business system. When a business system signals a problem, the comparative value indicates its importance of the problem as well as the business impact to the operator. The higher the value and more severe the impact, the more critical the business system is to the overall importance of the company. Additionally, the administrator may provide a list of the comparative values and criticality values to the business groups for review.

The idea presented here is that different parts of the business may be more or less important at different times of day and for different reasons. Ultimately, however, a single prioritized list of business systems is present at any given point in time, although that prioritized list may change over time because of different factors. Thus, the values of the company will vary over the different business systems and over the time of day.

As a normalizing factor, the administrator will establish benchmarks that allow the different business units to respond to the questions in a consistent manner. An example of benchmarking is: How important is this business system at peak hours?
‘Extremely important’-Expecting employees to get out of bed in the middle of the night to fix the problem,
‘Important’—Expecting employees to handle the problem first thing in the morning,
‘Not very important’—Expecting the problem to be fixed by the end of the week, and
‘Unimportant’—No concern when the problem is fixed.

After all of these factors are addressed, then each of the ranked services is analyzed to identify the internal business systems, networks, elements, SLAs, regulations, etc., that those services depend upon, and those service dependencies are then ranked in order of importance and have a numeric value and impact statement associated with them (block 504). Once each service and service dependency has been assigned a numerical value and impact statement, then the values associated with the particular business service are calculated and normalized (block 506) to produce a criticality value (block 508). An exemplary normalization process would be linear normalization. In linear normalization, numbers are converted in one range of data to numbers in a desired range. This is accomplished using the simple linear equation y=mx+b, where y is the new number in the desired range, x is the source number from the range to be converted, b is the amount of shift to be applied to the new number so that the lowest resulting number is zero, and m is the ratio between the range that is being converted to and the range that is being converted from.

Thus, the criticality value is the value assigned to any incoming problem that affects the particular service identified by the customer or within a network or system. An incoming problem can have its own severity which can be combined arithmetically with the criticality value of the business service to produce the criticality value of the problem. The criticality values can be normalized to fit within a range configurable by the administrator. An example would be where the set of criticality values may fall between 0 and 545. The administrator may want all the values to be between 0 and 100. Using the exemplary linear normalization equation above, the system can convert the values from the first range to the range specified by the administrator. For example, the number 545 in the source range would convert to 100 in the target range, and 272 would convert to 50.

In order for the process described in FIG. 5 to identify the most critical problem, two different stages of configuration must be made to the system management software. These stages are the administration time and the runtime. Administration time is where the administrator of a complex piece of software has already installed the software, and is now setting it up to run. Typical administration activities include creating User IDs, configuring the software, creating profiles, customizations, modeling, and preparing the software for the lower skilled operators or end users. Runtime is where the administrator has completed setting up the software and has handed it over to the operators or end users. Typically, the operators or end users are not allowed to configure the software; however, they may be allowed to set some user preferences. Operators or end users use systems management software for its intended purpose, e.g., to manage complex systems, or to diagnose problems, or to respond to problems reported by other users. During runtime, the operators or end users use the functions the administrator has prepared for them. Much of what the administrator has done is hidden and under the covers to the typical operator.

During the first stage, as the administrator is setting up the systems management software, the administrator will be presented with a sequence of questions that will query what the most important aspects of the business are. The administrator typically solicits input from the business side of the house for information about their business processes and revenue dependencies.

The system administrator can label the business services and resources directly with input from the business people, or the system administrator can create a form that enables the business personnel to label their own business services and feed this information directly into the software. All of the various groups within the business (e.g., IT, Finance, Order processing, Sales) could provide their input as to which systems, resources and lines of business are most important to the revenue of the company.

Typical questions posed to the administrator may include, for example:
What are the revenue streams generated by the service;
What type of business services are provided;
What are the times of the day, times of the week, and times of the year when the services are most critical? For example, in NYC at 1 AM EST, the store front may be closed with no revenue stream, but the store front in China at 2 PM local time are open and bringing in revenue;
How important each of the provided services is to the business;
What are the dependencies of the services on internal business elements;
What are the dependencies of one business service upon other business service that do not share common IT services
How does the geographic location of the customer affect the revenue stream;
What are the related service or dependent business elements;
What types of Service Level Agreements (SLA) that govern this service;
What is the degree of governmental regulations that control this service, etc.
   This information may be collected in a questionnaire, via an electronic form within a graphical user interface.

Once the business services and service dependencies are identified, a criticality equation 600 is calculated as shown in FIG. 6 in accordance with an exemplary embodiment of the present invention. The criticality equation 600 identifies a numerical criticality value 602 on the left side ranging from “0,” which would indicate no value, to “100,” which would indicate the most critical value. Each company service, computer, software, data line, etc., would have this value associated with it by the administrator with respect to the benchmarking and business input previously described. This value range is configurable by the administrator.

On the right side of the criticality equation is each criticality contributor 604 that will have a weight associated with it (range 0.00-1.00), assigned in the system after interrogating the administrator. This weight may also be configurable by the administrator. The sum of all the weights equals 1 (or 100%). Therefore, when each individual contributing value (between 0-100) is weighted and summed, the resulting criticality value is between 0 and 100.

FIG. 7 depicts how each criticality contributor contributes to the criticality value in accordance with an exemplary embodiment of the present invention. Each criticality contributor 702-708 has an associated numeric value (range 0-100). The numeric value may be assigned by the system from information collected while interrogating the administrator or it may be configured directly by an administrator. For example, high priority business services might have a value of 100. A slightly lower priority service might have a value of 80. A low priority service might have a value of 10 or 20. As an additional example, a problem that occurs between 9 am and 5 pm might have a contributing value of 100, whereas the same problem that occurs between 10 pm and 5 am might have a contributing value of only 10.

The following table is an example of how the criticality values may be calculated for three different business systems based on three different incidents. The criticality equation used in this example is: Criticality Value=(Incident Severity*Incident Weight)+(Business System Weight*[(Percentage of Daily Revenue*Revenue Weight)+(SLA Impact*SLA Weight)]). All three incidents use Incident Weight=0.25 (25%), Business System Weight=0.75 (75%), Revenue Weight=0.5 (50%), and SLA Weight=0.5 (50%).

| Incident | Inputs | Value |
|---|---|---|
| 1 | Incident severity = 100 percent | 5.00 |
| | Percent of Daily Revenue = 0.003 | |
| | SLA Impact = 10 | |
| 2 | Incident severity = 30 percent | 40.07 |
| | Percent of Daily Revenue = 16.667 | |
| | SLA Impact = 90 | |
| 3 | Incident severity = 75 percent | 42.66 |
| | Percent of Daily Revenue = 66 | |
| | SLA Impact = 25 | |

As indicated in the above table, Incident 1 describes a database that is not responding at 11:00 pm. The Database is on server A and impacts Business System X. Thus, Incident 1 has a severity of 100 percent, which means it causes the service it supports to be completely unavailable. Business System X generates $10,000 in revenue between 10 pm and 8 am. This is a small amount of revenue compared to the $30,000,000 brought in each day, so its relative impact is small (10,000/30,000,000=0.003% of revenue). Business System X being unavailable will not affect the SLA unless it is not fixed by 8 am; therefore it has a low impact, say 10 out of 100.

Incident 2 describes a file system approaching limit at 11:01 pm. The file system is on server B that impacts Business System Y. Incident 2 has a severity of 30, which means it is just a warning; it is not severely impacting the business system. Business System Y generates $5,000,000 in revenue between 10 pm and 8 am. This is a significant amount of revenue compared to the $30,000,000 brought in each day, so its relative impact is much higher (5,000,000/30,000,0000=16.666% of revenue) Business System Y is very close to breaching its SLA because it has already experienced downtime this month. This requires a high impact, say 90 out of 100.

Incident 3 describes a periodic loss of connectivity to some systems. The periodic loss occurs two hours before close of business on payday. The periodic loss affects server C, which impacts Bank System Z. Incident 2 has a severity of 75, which means it is system is experiencing issues and will be needed very soon; it may severely impact the business. Business System Z generates $4,000,000 in revenue between 4 pm and 10 pm. This is a significant amount of revenue compared to the $6,000,000 brought in each day, so its relative impact is much higher (4,000,000/6,000,000=66% of revenue). Business System Y is not close to breaching its SLA so the SLA is 25.

As can be seen, Incident 1 has a criticality value of 5.00, Incident 2 has a criticality value of 40.07 and Incident 3 has a criticality value of 42.66. Even though Incident 1 has completely impaired its associated business system and Incident 2 has not yet taken its business system offline, Incident 2 gets a much higher criticality value because its affected systems are much more important to the business. Incident 3 has a criticality value greater than incident 1 and 2 because the systems impacted will become even more critical as the business nears its busiest time of the day. Additionally, although the above examples provide the criticality value, the criticality value may likewise be indicated in other means. For example, the criticality value may be banded in a range and shown by color (either icon or colored text) e.g. “red” for extremely critical, “orange” for critical, “yellow” for important, etc.

Removing the cap of 100 may also be considered. For example, if an ATM service goes down, that might be a priority 1 service and contribute the maximum amount of 100*weight factor to criticality value 710. However, if the ATM business service and Internet Banking business service both go down because of the same problem, then they need to contribute even more value to the criticality even though they are already contributing the maximum business impact. Another way to go about this is to decrease the contributing amount of a single service to 50 and sum the values of multiple services (to a maximum of 100), and increase the weighting factor of the service contributor to the overall criticality value 710.

Once the most critical business services are assigned a criticality value, then the software would receive the problems and compare the numerical criticality values with all other criticality values in the NOC queue at any one time.

From a runtime point of view, the operator would no longer see huge lists of problems to work, or large screens of resources interconnected with each other with different colors to represent problem severity. All the operator would see is a much smaller number of the most critical problems. Screen real estate on the operator's console would be freed up from the potentially long lists of problems to show more of the diagnostic and resolution tools. The operators would no longer have to fumble around with guessing which problem is the most critical. There is also an idea called “tribal knowledge” where the operator learns over time (and via mistakes) which problems are the most critical to work first. The call centers could be staffed with relatively less skilled people because the software would tell them which to work first, and the operators not having to develop over time the skills and tribal knowledge.

The determination of the problem that is most critical is made by the software criticality value. This value may be dynamically adjusted or recalculated based upon changes in the environment. An example of possible changes may be new events entering the system indicating related failures from other hardware and software, changes in the degree of failures, and changes to the rules by an administrator. The system management software always promotes to the top of the work queue the most important problem to work.

The system may decide on preemption based on a threshold. The threshold is compared against the difference between the new problem's criticality value and the current problem's criticality value. If the difference is greater than the threshold and the new problem has a higher value, then the current problem is preempted by the new problem. The threshold may be set by the administrator or may be adjusted by the system over time using a learning algorithm. An example of a learning algorithm would be a Q-learning. In Q-learning, a value for the preemption threshold is initialized, either by a programmer or administrator. As the system preempts incidents that operators are working, it can observe the consequence of the preemption. The consequence might be observed by an operator or administrator conveying to the system that it was a good or bad choice. The system then compares the consequence observed with the maximum reward possible and produces a new threshold based on the well-known Q-learning algorithm.

In summary, the present invention provides a method, apparatus and computer instructions to identify problems that are most critical to a business so as to achieve management by business impact. The exemplary aspects of the present invention facilitate a way to configure business systems management software to ensure that the most severe problems that impact the business revenue are addressed first. The exemplary aspects of the present invention interrogate an administrator for the business as to those systems, business services, resources and customers whom the business feels are most important to the business' bottom line. Through a rule-based set of GUI constructs, the administrator configures the software system to ensure the most severe problems are addressed first.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for prioritizing computer related problems based on the respective business criticality for each of the problems, the method comprising:
associating an assigned business value based on the actual business value to at least one service of a plurality of services;
queuing a plurality of computer related problems;
associating each of the plurality of computer related problems to one of the at least one service;
determining a business criticality value associated with each of the computer related problems based on the assigned business value of the associated at least one service; and
providing access to a prioritized list of the plurality of computer related problems and associated criticality values so that it may be displayed on a user data processing system in communication with the data processing system.

2. The method of claim 1, further comprising:
listing at least one service, wherein the at least one service provides an actual business value to the business.

3. The method of claim 2, wherein the step of listing the at least one service includes listing at least one service dependency associated with the at least one service and the step of associating each of the plurality of computer related problems with at least one service uses the associated service dependency.

4. The method of claim 3, wherein the step of associating an assigned business value to each of the at least one service includes using an assigned business value of a second service dependent upon the at least one service based on the at least one service dependency.

5. The method of claim 3, wherein the step of determining a business criticality value includes using the assigned business value of each of the at least one service and the assigned business value of a second service dependent upon the at least one service based on at least one service dependency.

6. The method of claim 1, further comprising:
determining a new computer related problem in the queue has a higher business criticality value than one of the prioritized plurality of computer related problems; and
prioritizing the new computer related problem within the prioritized plurality of computer related problems.

7. The method of claim 1, wherein the assigned business value of the at least one service is dynamically determined according to a business value associated with a time of day.

8. The method of claim 1, wherein the assigned business value of the at least one service is determined according to a term of a service level agreement.

9. The method of claim 1, wherein the assigned business value of the at least one service is determined according to user input to a rule based set of GUI constructs

10. The method of claim 1, wherein the assigned business value of the at least one service is determined according to compliance with a government regulation.

11. The method of claim 1, wherein the assigned business value of the at least one service is determined according to a geographic location of a customer.

12. The method of claim 1, further comprising:
determining one or more computer related problems from the prioritized list of the plurality of computer related problems with the highest business criticality value from the queue; and
prioritizing the computer related problems in order of priority based on the business criticality value.

13. A data processing system comprising:
a bus system;
a communications system connected to the bus system;
a memory connected to the bus system, wherein the memory includes a set of instructions; and
a processing unit connected to the bus system, wherein the processing unit executes the set of instructions to associate an assigned business value based on the actual business value to at least one service of a plurality of services; queue a plurality of computer related problems; associate each of the plurality of computer related problems to one of the at least one service; determine a business criticality value associated with each of the computer related problems based on the assigned business value of the associated at least one service; and provide access to a prioritized list of the plurality of computer related problems and associated criticality values so that it may be displayed on a user data processing system in communication with the data processing system.

14. The data processing system of claim 13, further comprising:
a set of instructions to list at least one service, wherein the at least one service provides an actual business value to the business.

15. The data processing system of claim 13, further comprising:
a set of instructions to determine a new computer related problem in the queue has a higher business criticality value than one of the prioritized plurality of computer related problems; and prioritize the new computer related problem within the prioritized plurality of computer related problems.

16. The data processing system of claim 13, further comprising:
a set of instructions to determine one or more computer related problems from the prioritized list of the plurality of computer related problems with the highest business criticality value from the queue; and prioritize the computer related problems in order of priority based on the business criticality value.

17. A computer program product in a computer readable medium for prioritizing computer related problems based on the respective business criticality for each of the problems, comprising:
instructions for associating an assigned business value based on the actual business value to at least one service of a plurality of services;
instructions for queuing a plurality of computer related problems;
instructions for associating each of the plurality of computer related problems to one of the at least one service;
instructions for determining a business criticality value associated with each of the computer related problems based on the assigned business value of the associated at least one service; and
instructions for providing access to a prioritized list of the plurality of computer related problems and associated criticality values so that it can be displayed on a user data processing system in communication with the data processing system.

18. The computer program product of claim 17, further comprising:
instructions for listing at least one service, wherein the at least one service provides an actual business value to the business.

19. The computer program product of claim 17, further comprising:
instructions for determining a new computer related problem in the queue has a higher business criticality value than one of the prioritized plurality of computer related problems; and
instructions for prioritizing the new computer related problem within the prioritized plurality of computer related problems.

20. The computer program product of claim 17, further comprising:
instructions for determining one or more computer related problems from the prioritized list of the plurality of computer related problems with the highest business criticality value from the queue; and
instructions for prioritizing the computer related problems in order of priority based on the business criticality value.
